(19) United States
(12) Patent Application Publication
(10) Pub. No.: US 2017/0000138 A1
(43) Pub. Date: Jan. 5, 2017

(54) Method For Producing A Starter Dough For Baking Baked Wheat Products Using Returned Wheat-Based Bread

(71) Applicant: DIOSNA DIERKS & SÖHNE GMBH, Osnabrück (DE)

(72) Inventors: Fridjof Olms, Isernhagen (DE); Katrin Laude, Burgwedel (DE); Torsten Zense, Uetze (DE)

(21) Appl. No.: 15/106,430

(22) PCT Filed: Dec. 23, 2014
(86) PCT No.: PCT/EP2014/079149

§ 371 Date: Jun. 20, 2016

(30) Foreign Application Priority Data
Dec. 23, 2013 (EP) 13199401.4

(51) Int. Cl. A21D 8/04; A21D 17/00

(52) U.S. Cl. CPC A21D 8/045; A21D 17/002; A21D 8/047; A23Y 2220/63; A23Y 2220/13; A23Y 2220/29; A23Y 2220/67

(57) ABSTRACT

A starter culture for making sourdough is disclosed, comprising a mixture of Lactobacillus paracasei BSB 2 DSM 28104 and Lactobacillus gallinarum BSB 1 DSM 28103.

Likewise disclosed is a method for producing a starter dough as a constituent of doughs for baking baked wheat products using a wheat bread contingent, including the following steps:
a) In a first stage, preparing a sourdough by mixing around 100 parts by weight wheat flour with 100-200 parts by weight water and inoculating the mixture with a starter thickened with milled cereal products and obtained from a culture of lactic acid bacteria, more particularly as a mixed culture of at least two complementary Lactobacillus species and yeast with a 20-35° C. temperature range, and ageing the resulting first mixture for a period of 12-36 hours.
b) In a second stage, producing a mixture of wheat flour, a wheat bread contingent and water, comprising an amount of 75-135 parts by weight, preferably 75-120 parts by weight wheat flour; of which 15-75 parts by weight, preferably 30-75 parts by weight wheat bread contingent, which is mixed with 150 parts by weight water for a time in particular of 10-120 minutes, preferably 30-60 minutes, with stirring in two steps, the product having a temperature in a range of 20-35° C.;
c) mixing part of the sourdough obtained in the first stage as per step a) with a greater part of the second mixture for initializing the fermentation of the second stage,
d) ageing the combined mixture obtained in step c) for a period of 24-60 hours, to give a starter dough as a constituent of doughs for making baked wheat products.

Starter dough as a constituent of doughs for making baked wheat products, obtainable by the method of the invention.

The present invention relates to a starter culture for making sourdough, to lactobacilli, to a process for producing a wheat-based sourdough with the addition of returned bread, and to a method for producing baked wheat products using the starter dough produced by the process according to the invention, and to a starter dough for producing baked wheat products obtainable by the method according to the invention.

Returned bread is a high quality product with valuable ingredients. Wikipedia reports that returned bread can be used as animal feed or processed to biofuel by alcoholic fermentation. Small amounts arrive at charitable institutions, such as soup kitchens, or at private animal fattening farms. In artisan bakeries, white bread and rolls that do not contain any seeds, spices or dried fruit are in part stored in a dry and warm place, and processed to breadcrumbs. In the production of wholemeal bread, bread pieces and returned bread are in part processed further into scalding sough or grain soaker, which serve the function of swell flour. The product becomes more juicy, and the structure of the crumb is improved in products made from whole grains. In the industry and small trade, the addition of returned bread is common practice in brown breads in order to improve the quality of the product and the costs situation. Processing to mill feed is widespread. In the Netherlands, system logistics have been developed for this purpose. Since the end of 2006, the feeding of kitchen waste and leftovers to livestock has been banned in Germany (EU Guideline 1774/2002). This ban does not apply to returned bread and pasta products. However, the legal guidelines valid for feed products are to be applied. Together with various undertakings, the Technical University of Berlin developed a method by which yeast is produced from returned bread. Stale bread is also used as a fuel. The use of marketable and perfectly hygienic bread in bread production is common in Germany according to the guiding principles for bread and biscuits [Reference 1] (deviating regulations may be valid in other European countries). In bread with a predominant proportion of wheat, the use of up to 6% of residual bread or returned bread, and up to 20% when the proportion of rye is predominant, is allowed, based on the total amount of cereals and/or cereal products employed. Considering the addition of water and other formulation ingredients for the production of bakery products, from 3 to 3.5% by weight in wheat (brown) breads and from 10 to 11% by weight in rye (rye-wheat) breads can thus be recycled as returned bread. One demand of the guiding principles [1] is that the “included bread is . . . not visible with the naked eye in the final product”.

Methods in which an addition of returned bread is effected through dried brown bread, rye-wheat bread and rye bread are known. A known procedure uses 10 kg of dried and ground bread, soaking it with 1.2 to 5 times the amount of water. The mixture swells in the course of an overnight resting time.

A drawback of the methods in which there is only swelling is the fact that in breads baked with such slurries, up to lentil-sized particles of the original breads can to some degree be found visibly in the crumb, and may in part be felt as supposed foreign bodies, at least as impurities. The German Agricultural Association DLG evaluates such particles as “stain” in the national quality evaluations of bread, evaluating them as bread defects.

Since bread represents a good breeding ground not only for beneficial organisms, such as lactic acid bacteria and yeasts, but also for potential spoilage germs, a residual bread slurry is to be processed within a few hours, especially at room temperature.

Generally, to any method that recycles the legally allowed proportions of food, or bread in this case, into the production process, it must be inherent that measures of hygiene and HACCP (Hazard Analysis and Critical Control Point; describes a system for the determination and documented supervision of control points in the process that are to ensure safety for human consumption of the products produced/processed/sold in the process according to a risk assessment) are preconditions in order that the recycling of material can be performed at all.

The problems of the utilization of bread are considered by the Landesanstalt für Umwelt, Messungen and Naturschutz (Regional Office for the Environment, Measurements and Protection of Nature) in Baden-Wuerttemberg [ref. 2]. It is set forth that “exclusively production residues, such as defective lots, are recycled in major chain-store bakeries, because the hygienic standards required for further processing . . . are not achieved by returned bread” [note: from branches].

In line productions, obtaining from 1 up to 3 percent of bread that is judged as not sellable for quality defects and is thus passed to returned bread recycling is considered a realistic order of magnitude. For an output of 1000 loaves per hour, this corresponds to a loss of 10 to 30 loaves per hour.

Losses or residues from bread production are obtained even if loaves are precut before they arrive in sale, mostly packaged. Typical “waste” quantities of sliced bread are obtained, for example, from the end pieces, which are often not included in the package. Also typical are “defective cuts” in slight shape deviations of the natural product bread, when a hard crust breaks off, etc.

In these examples, it is also seen why the exploration of the possibilities of utilizing returned bread is an important topic.

One technical problem underlying the invention is the provision of a method by which residues from baked wheat products can be recycled into a baking process. Another technical problem is the avoidance of visible stains in bread. Another object of the present invention is to provide means for performing the method, especially the creation of starter cultures for the fermentation and production of a sourdough.

According to the invention, the problems are solved by a process for producing a fermented starter dough from returned bread as an ingredient of doughs for baking baked wheat products.

Especially suitable for performing the process according to the invention is a starter culture for producing sourdough, containing a mixture of Lactobacillus paracasei BSB 2 DSM 28104 and/or Lactobacillus gallinarum BSB 1 DSM 28103.

In one embodiment of the starter culture according to the invention, it may contain Lactobacillus paracasei BSB 2 DSM 28104 and/or Lactobacillus gallinarum BSB 1 DSM 28103 as well as other lactobacilli and yeasts, and ground cereal products for producing a thickened storable mixture that is suitable for selling.

In another embodiment of the starter culture according to the invention, the starter culture may contain at least one other of the components mentioned in the following: Lactobacillus paracasei BSB 2 DSM 28104 and/or Lactobacillus gallinarum BSB 1 DSM 28103, additionally Lactobacillus brevis, Lactobacillus delbrueckii, Lactobacillus plantarum, and Saccharomyces cerevisiae, as well as rye meal, rye flour and water.

In yet another embodiment of the starter culture according to the invention, it may contain from 0.005 to 0.2% by weight, especially about 0.02% by weight, of said mixture of microorganism cultures, including from 0.005 to 0.2% by weight, especially about 0.018% by weight, of Lactobacillus paracasei BSB 2 DSM 28104 and/or Lactobacillus gallinarum BSB 1 DSM 28103, and from 40 to 60% by weight of rye meal, especially from 45 to 50% by weight of rye meal, from 20 to 30% by weight of rye flour, especially 25% by weight of rye flour, and from 20 to 30% by weight, especially 25% by weight, of water.

The present invention also relates to Lactobacillus paracasei BSB 2 Accession No. DSM 28104 and Lactobacillus gallinarum BSB 1 Accession No. DSM 28103. These strains were deposited on Dec. 19, 2014, with the collection Leibniz Institut DSMZ—Deutsche Sammlung von Mikroorganismen und Zellkulturen GmbH, Inhoffenstraβe 7B, D-38124 Braunschweig, Germany, under the provisions of the Budapest treaty.

The process according to the invention comprises the following steps:
a) in a first step, preparing a sourdough by mixing about 100 weight parts of wheat flour with 100-200 weight parts of water, and inoculating with a starter, thickened with ground cereal products, obtained from a culture of lactic acid bacteria, especially a mixed culture of at least two, especially three, mutually complementary Lactobacillus species, such as those that may be selected from the group consisting of Lactobacillus brevis, L. acidophilus, L. delbrueckii, L. fermentum, L. gallinarum, L. helveticus, L. paracasei, L. plantarum, L. sanfranciscensis, L. ultunensis or Leuconostoc mesenteroides, and yeasts (Saccharomyces cerevisiae, Candida var., and Hansenula var.), in a temperature range of 20-35° C., preferably 26-32° C., and allowing the first mixture obtained to ripen for a period of 12-36 h, preferably from 20 to 28 hours. The Lactobacillus strains Lactobacillus paracasei BSB 2 DSM 28104 and/or Lactobacillus gallinarum BSB 1 DSM 28103 have proven particularly advantageous;
b) in a second step, preparing a mixture of wheat flour, a contingent of wheat bread and water, comprising an amount of 75-135 weight parts, preferably 75-120 weight parts, of wheat flour; of which 15-75 weight parts, preferably 30-75 weight parts, is a contingent of wheat bread, mixed with 150 weight parts of water, in particular, for a period of 10-120 min, preferably 30-60 min, with stirring in two steps, wherein the product should have a temperature within a temperature range of 20-35° C.;
c) mixing part of the sourdough obtained in the first step according to step a) with a greater part of the second mixture to initiate the fermentation of the second step;
d) allowing the combined mixture obtained in step c) to ripen for a period of 24-72 h, preferably 36-60 h, to obtain a starter dough as a component of doughs for producing said baked wheat products.

The ratios of the added amounts of a) and b) for the combined mixture in step c) can be determined and set by the skilled person easily using their technical knowledge. Typically, they are selected depending on both the quality of the first step from a) and the quality of the second step from b). For example, the selection of the amount of a) to be introduced into the mixture of a) and b) depends on growth advantages for some microorganisms of the mixed culture over others, utilizing the whole range of temperature, wherein the property of initiating the fermentation of the second step is maintained, in particular, with its peculiarity according to the invention of utilizing and digesting returned bread. In the case of the second step, the selection depends, for example, on the composition of the contingent employed of wheat bread as a returned bread. The user of the process sets the composition of the contingent of wheat bread as a returned bread on the basis of their article mix, so that the addition ratio is commonly defined thereupon.

Typically, in the process according to the invention, 5.0 to 20.0 weight parts of the first step a) is mixed with 100 weight parts of the second mixture b) for preparing the second step.

The problem of the potential breeding ground also for spoilage germs is solved by the fact that a selected starter dough fermentation lowers the pH to a point where a very long natural storage stability is achieved.

This stability is achieved by the combination of the starter culture developed by the inventor in connection with the guiding parameters developed for it.

Generally, a fermentation inhibits the development of spoilage organisms by the constant lowering of the pH, and the possible germ counts of these organisms that can be reached at all are kept low from the beginning for this mere reason.

The process according to the invention enables particularly low pH values of up to pH 3.4 to be achieved naturally, whereby a natural storage stability of the starter dough of up to 96 hours, maximally up to 144 hours, is reached even without cooling.

An essential advantage of the process according to the invention is the fact that the use of returned bread is not effected by mechanical processes alone, supported by swelling mechanisms, but a fermentation is initiated that proceeds in a controlled and selective way by the selection of the microorganisms and corresponding parameter settings.

It is characteristic that the fermentation includes decomposition and conversion processes. The former lead, among others, to an enhanced digestion of the components of the returned bread, and the latter lead to the formation of natural lactic and acetic acids, which enable both the primary flavor-forming and, by lowering the pH, the prolonged storage stability of the sourdough after completion of the maturation process. The natural fermentation is at the same time critical to the application of the term natural sourdough, which can also be adapted for the process according to the invention.

In one embodiment of the process according to the invention, wheat flour of type 550 according to DIN 10355 is employed in the sourdough steps, which corresponds to an ash content of from 510 to 630 mg/100 g of flour. In one modification, the extraction rate of the flour is from 640 to 900 mg/100 g, in another embodiment from 910 to 1200 mg/100 g, in particular embodiments from 1210 to 2100 mg/100 g of flour.

In another embodiment, the first mixture ripens for a period of 12-36 h, preferably 20-28 h, in a temperature range of 20-35° C., preferably at 26-32° C., according to the invention.

In the process according to the invention, approximately 100 weight parts of wheat flour is mixed with 100-200 weight parts of water especially in the first step.

Typically, from 5.0 to 20.0 weight parts of the first step is mixed with 100 weight parts of the second mixture in the process according to the invention for preparing the second step, the second mixture being allowed to ripen at 20-35° C., preferably at 26-32° C., for a period of 24-72 h, preferably 36-60 h.

The starter dough that can be prepared by the process according to the invention as a component of the main dough can advantageously be employed for baking baked wheat products, but also in wheat-rye mixed baked products.

The invention also relates to a temporarily storable starter dough obtainable by the process according to the invention for the direct addition to dough for baking baked wheat products as well as wheat-rye mixed baked products.

The invention is further illustrated in the following Example.

### Wheat Bread Fermentation

1st step (in an insulated container, e.g., an IsoFermenter from the company IsernHäger):
mix 15 liters of temperature-controlled water+10 kg of wheat flour type 550; or any other mixture of water and flour that corresponds to this ratio;
set temperature after mixing: 29° C.;
take the mixed culture, which was thickened with baking meal and flour and rendered storable in a commercially common way, referred to as a wheat bread fermentation starter in the following, from the refrigerator and crumble it in a dish;
add the wheat bread fermentation starter to the temperature-controlled water/flour mixture;
maturing time: 24 hours

2nd step (in an apparatus B300 of the company IsernHäger):
firstly add about 80% of the required temperature-controlled water, followed by adding 50% of the amount of returned bread into the system, and start a comminuting and mixing program;
after 5 minutes, add the remaining amount of bread to the system, and restart system;
after another 5 minutes, add the required amount of wheat flour, and restart system;
allow to stir for 10 min;
subsequently add the prepared 1st step and the remaining almost 20% water. The temperature after the mixing of all components should be at 30° C.;
maturing time: 48 hours.

The fermented starter dough prepared is a sourdough that can be employed as a component of a main dough advantageously for baking baked wheat products, but also in wheat-rye mixed baked products. According to the invention, particularly low pH values of up to pH 3.5 are reached in a natural way by a combination of the starter culture developed by the inventor himself in connection with the specifically developed guiding parameters according to the process description, whereby a natural storage stability of the starter dough of up to 96 hours, maximally up to 144 hours, is achieved even without cooling.

Therefore, the invention also relates to a starter dough obtainable by the process according to the invention and storable for up to 144 hours for the direct addition to dough for baking baked wheat products, and wheat-rye mixed baked products.

### EXAMPLE 1

The application of the two-step process with concretely stated amounts and fermentation parameters can be performed as follows, for example:

15.000 kg of water and 10.000 kg of wheat flour with an ash content of 510 to 630 mg/100 g of flour are mixed. The water temperature is selected in such a way that the temperature of the mixture is 29° C.+1.5/−0.5° C. 0.750 kg of the wheat bread fermentation starter is taken out of the refrigerator and crumbled in a dish. Subsequently, the starter is stirred among the water/flour mixture. This should be done in an as well as possible temperature-insulated closable container, such as offered by an isofermenter of the company IsernHäger, whose filling volume is 70 liters, for example, for this scale.

The 1st step prepared in this way is now subjected to a fermentation time of 24 hours. When the admixing temperature is correct and the container well insulated, the fermentation temperature will be typically between 29 and 33° C.

The 1st step started by this method can be used for up to 48 hours for starting a 2nd step.

In this Example, a fermentation plant of type B300 from the company IsernHäger is employed for starting the 2nd step. This plant is a stainless steel container suitable to receive 300 kg and having a filling volume of about 390 liters, which contains a cutter/agitator with a stator and a rotor, capable of comminuting returned bread loaves as well as bread slices, and is accordingly equipped with a high-power engine, and enables agitator control and a process course according to different parameters.

At first, 120 kg of water is metered into the fermenter, temperature-controlled in such a way that, considering the temperatures of all ingredients, a mixing temperature of 30° C.±2° C. is ultimately achieved. Subsequently, half of the wheat-based returned bread to be processed, 37.5 kg in this Example, is added to the fermenter. In a comminuting and mixing program, the returned bread is coarsely comminuted over a period of 5 minutes. Now, the second half, corresponding to 37.5 kg, of the returned bread is added, and the comminuting and mixing program is again in operation for a running time of 5 minutes.

Now, the addition of 75 kg of wheat flour is performed, and the plant executes a ten minutes mixing phase.

As a last step, the admixing of the proportion of the 1st step, 25.75 kg in this Example, and finally the residual amount of 30 kg of water, is performed. The target temperature of the combined mixture, as stated above, is 30° C.±2° C.

The 2nd step prepared in this way now goes through a fermentation time of 60 to 66 hours in this Example. Depending on the room temperature, the fermentation temperature will typically be between 25 and 33° C.

The fermentative maturity, which is important to the use of the starter dough in formulations for preparing baked wheat products, expresses itself in the acidification. The acidification is considered complete when the pH and the amount of acid formed, determined as the degree of acidity, have begun to form a plateau in a graphic plot over the time axis. From now on, the storage stability, which is achieved with utilization of the returned bread fraction according to the invention, enables the long processability of the starter dough for equal processing properties.

Even a little post-ripening beyond this time due to the active culture will change the dough qualities and later pastry qualities only so slightly that they are not sensorially detectable from the consumer's point of view.

Typically, and depending on the described development of the mixed culture and the composition of the baked wheat products employed as returned bread, the plateau and the beginning of the processing time are characterized in that the achieved pH is lower than 4.0, and that the degree of acidity achieved is higher than 16. The natural storage stability of the thus acidified starter dough of the 2nd step is up to 144 hours.

A dough formulation for preparing a baked wheat product using the starter dough produced by the process described is shown in the following Table. In the present Example, a moderate added amount of 6 parts of wheat flour plus 6 parts of water, designated as “wheat bread fermentation” starter dough, based on 100 parts of the wheat flour employed, has been selected. According to current recommendations, the salt content has been set at 1.5 percent, based on the flour. The moderate added amount of starter dough in this Example is suitable if the expectation of the final consumer relating to taste of the wheat bread, such as for a sandwich bread, rather considers a mild bread taste.

Wheat bread
Basis:
100 kg of total flour

| Dough ingredients | in kg | Production parameters | |
|---|---|---|---|
| Dough | | Dough resting time: | 48 min |
| “Wheat bread | 12.000 | Proportion of starter dough, | 6.0% |
| fermentation” | | expressed as proportion of | |
| starter dough | | wheat flour, fermented: | |
| (at a flour-to-water | | Dough yield: | 150.5 |
| ratio of 1:1) | | | |
| Wheat flour | 94.000 | Dough temperature: | 27-28 |
| Yeast | 3.400 | Added yeast in %: | 3.4% |
| Salt | 1.500 | Salt content in %: | 1.5% |
| Water | 44.500 | Dough employed for 1 loaf: | 0.900 kg |
| Dough weight: | 155.400 | Resulting number of loaves | 172.7 |
| | | (weight after baking loss: | |
| | | 0.750 kg): | |

| Processing: | Kneading times (spiral kneader): | | |
|---|---|---|---|
| Round- and | slow: | 3 | min |
| long-molding | fast: | 10 | min |
| | Final proof: | | |
| | Temperature: | 35° | C. |

| Atmospheric humidity: | 85% | |
|---|---|---|
| Time: | 65 | min |
| Baking process: | | |
| Baking temperature start: | 250° | C. |
| Baking temperature end: | 210° | C. |
| Time: | 33 | min |

According to this formulation, 4 loaves of 0.750 kg each, in arithmetical terms, were processed in the 3 parts (of a total of 6 parts) of starter dough coming from the returned bread, which means the utilization of a returned bread proportion of 2.3 percent, based on a total of 172.7 loaves.

However, the user of the process can extend the use of a starter dough from the process depending on the product. For example, in a savory wheat bread, like Ciabatta, the proportion could be extended to up to 12 of 100 parts of wheat flour, or to up to 6 parts of returned bread. Ultimately, the added amount is up to the user, if they only observe the guidelines for the utilization of returned bread (see Introduction, page 2, lines 1 et seq.).

### LITERATURE

[1] Bundesministerium für Ernährung, Landwirtschaft und Verbraucherschutz (Ed.): Leitsätze des Deutschen Lebensmittelbuchs für Brot und Kleingebäck of Oct. 19, 1993, last changed on Sep. 19, 2005

[2] Landesanstalt für Umwelt, Messungen und Naturschutz Baden-Württemberg: Ideen für mögliche Abfallvermeidung in Baden-Württemberg. Free download under: www.lubw.baden-wuerttemberg.de, ISBN 978-3-88251-374-5, as of May 2013

1. A starter culture for producing sourdough, comprising a mixture of Lactobacillus paracasei BSB 2 DSM 28104 and/or Lactobacillus gallinarum BSB 1 DSM 28103.

2. The starter culture according to claim 1, comprising Lactobacillus paracasei BSB 2 DSM 28104 and/or Lactobacillus gallinarum BSB 1 DSM 28103, further comprising other lactobacilli and yeasts, which commonly form a mixture of microorganism cultures, and ground cereal products.

3. The starter culture according to claim 2, wherein the mixture of microorganism cultures comprises Lactobacillus paracasei BSB 2 DSM 28104 and/or Lactobacillus gallinarum BSB 1 DSM 28103, Lactobacillus brevis, Lactobacillus delbrueckii, Lactobacillus plantarum, Saccharomyces cerevisiae, and wherein the ground cereal products comprise rye meal, rye flour and water.

4. The starter culture according to claim 2 having from 0.005 to 0.2% by weight of said mixture of microorganism cultures, including from 0.005 to 0.2% by weight of Lactobacillus paracasei BSB 2 DSM 28104 and/or Lactobacillus gallinarum BSB 1 DSM 28103, and from 40 to 60% by weight of rye meal, from 20 to 30% by weight of rye flour, and from 20 to 30% by weight of water.

5. Lactobacillus paracasei BSB 2 DSM 28104 and/or Lactobacillus gallinarum BSB 1 DSM 28103.

6. (canceled)

7. A process for producing a starter dough as a component of doughs for baking baked wheat products using a wheat bread contingent, comprising:
a) in a first step, preparing a sourdough by mixing about 100 weight parts of wheat flour with 100-200 weight parts of water, and inoculating with a starter, thickened with ground cereal products obtained from lactic acid bacteria and yeast, whose temperature range is from 20 to 35° C., and allowing the first mixture obtained to ripen for a period of 12-36 h;
b) in a second step, preparing a mixture of wheat flour, a contingent of wheat bread and water, comprising an amount of 75-135 weight parts of wheat flour; of which 15-75 weight parts is a contingent of wheat bread, which is mixed with 150 weight parts of water for a period of 10-120 min with stirring in two steps, wherein the product has a temperature within a temperature range of 20-35° C.;
c) mixing part of the sourdough obtained in the first step according to step a) with a greater part of the second mixture to initiate the fermentation of the second step;
d) allowing the combined mixture obtained in step c) to ripen for a period of 24-60 h, to obtain a starter dough as a component of doughs for producing said baked wheat products.

8. The process according to claim 7, wherein a starter culture is employed that comprises Lactobacillus paracasei BSB 2 DSM 28104 and/or Lactobacillus gallinarum BSB 1 DSM 28103.

9. The process according to claim 7, wherein said wheat flour is a flour of type 550 according to DIN 10355, which corresponds to an ash content of from 510 to 630 mg/100 g of flour, flour with an extraction rate of from 640 to 900 mg/100 g, especially from 910 to 1200 mg/100 g, or from 1210 to 2100 mg/100 g of flour.

10. The process according to claim 7, wherein the combined second step is allowed to ripen at 20-35° C. for a period of 20-48 h.

11. The process according to claim 7 wherein from 2.5 to 15.0 weight parts of the first step is mixed with 100 weight parts of the second mixture to prepare the combined second step.

12. The process according to claim 7 in which a conditional natural storage stability of maximally up to 144 hours is achieved, without cooling, by reaching a low pH value of up to pH 3.5 in a process based merely on fermentation.

13. A process for producing a starter dough for baking baked wheat products, characterized by the proportionate utilization of returned wheat bread using the starter dough produced by a process according to claim 11.

14. A starter dough as a component of doughs for preparing baked wheat products, obtainable by a process comprising producing a starter dough for baking baked wheat products, characterized by the proportionate utilization of returned wheat bread using the starter dough produced by a process according to claim 11.
